(19) United States
(12) Patent Application Publication
(10) Pub. No.: US 2016/0017817 A1
(43) Pub. Date: Jan. 21, 2016

(54) METERING DEVICE FOR A FUEL FEED CIRCUIT OF AN ENGINE

(71) Applicant: TURBOMECA, Bordes (FR)

(72) Inventors: Stephen LANGFORD, Pau (FR); Philippe Jean, Rene, Marie BENEZECH, Morlaas (FR); Pierre SICAIRE, Pau (FR); Rafael SAMSON, Lit Et Mixe (FR)

(73) Assignee: TURBOMECA, Bordes (FR)

(21) Appl. No.: 14/773,569

(22) PCT Filed: Mar. 7, 2014
(86) PCT No.: PCT/FR14/50521

§ 371 Date: Sep. 8, 2015

(30) Foreign Application Priority Data
Mar. 12, 2013 (FR) 1352169

(51) Int. Cl. F02C 9/26

(52) U.S. Cl. CPC F02C 9/263

(57) ABSTRACT

A metering device for an engine fuel feed circuit, the device including a metering valve, and a pressure regulator device maintaining a constant pressure difference from downstream to upstream across the metering valve, wherein the metering valve includes a seat provided with an inlet orifice and an outlet orifice, a shutter arranged within the seat, and an actuator controlling the position of the shutter, and wherein, between the inlet orifice and the outlet orifice the shutter defines a passage of minimum section that is variable as a function of the position of the shutter along a stroke extending between a bottom abutment and a top abutment and passing via a threshold position.

### FIELD OF THE INVENTION

The present invention relates to a metering device for a fuel feed circuit of an engine.

It may be used to meter the fuel fed to any type of fuel-burning engine, and in particular to turbine engines of a helicopter or an airplane.

### STATE OF THE PRIOR ART

In a helicopter, the fuel circuit of the turbine engine typically performs several functions: it serves to suck fuel from the tank, to put it under pressure, to meter it in application of a setpoint provided by a computer, and finally to distribute the fuel to injectors.

In order to meter the fuel, the fuel circuit may include a metering unit having a controllable valve. Various metering relationships can be used for controlling the valve.

Certain conventional metering units make use of “linear” relationships: with such a relationship, the fuel flow rate as controlled by the valve increases linearly with movement of the shutter member of the valve along its stroke. Nevertheless, such linear type metering units are poorly adapted to maintaining high flow rate ranges because of the constant slope of the metering relationship starting from the minimum flow rate. In addition, that relationship can accommodate only small-amplitude “growth”, i.e. increases in the nominal fuel flow rate while conserving the architecture of the existing fuel circuit, since the resolution at low flow rate of such a metering system must be preserved.

Other known metering units make use of “exponential” relationships: with such a relationship, the fuel flow rate as controlled by the valve increases exponentially with movement of the valve shutter along its stroke. Nevertheless, such units are complex to use in the event of a failure of the actuator controlling the valve, specifically because of the non-linear nature of their metering relationship that is poorly suited for incremental control (e.g. control by a stepper motor): under such circumstances, a small error in the position of the shutter, e.g. the loss of one step, can lead to a large error in the metering of fuel. In addition, it is also difficult to adjust such units when resetting the pressure difference that exists across the valve, since any gain caused by such resetting is not constant over the slope of the metering relationship.

There thus exists a real need for a metering device for a fuel feed circuit that does not suffer, at least to such an extent, from the drawbacks inherent to the above-mentioned known metering devices.

### SUMMARY OF THE INVENTION

The present description relates to a metering device for an engine fuel feed circuit, the device comprising a metering valve, and a pressure regulator device maintaining a constant pressure difference from downstream to upstream across the metering valve, wherein the metering valve comprises a seat provided with an inlet orifice and an outlet orifice, a shutter arranged within the seat, and an actuator controlling the position of the shutter, wherein, between the inlet orifice and the outlet orifice, the shutter defines a passage of minimum section that is variable as a function of the position of the shutter along a stroke extending between a bottom abutment and a top abutment and passing via a threshold position. The shutter is configured in such a manner that, firstly, the minimum section of said passage, and thus the flow rate of fuel passing through the valve, increases linearly as a function of the position coordinate of the shutter between the bottom abutment and the threshold position, and that, secondly, the minimum section of said passage, and thus of the fuel flow rate, increases quadratically or more rapidly, as a function of the position coordinate of the shutter between the threshold position and the top abutment.

In application of Bernoulli's theorem, when the pressure difference from downstream to upstream across the metering valve is kept constant by the pressure regulator device, the speed of the fuel flowing through the metering device is constant. Under such circumstances, the flow rate of the fuel flowing through the metering device is directly proportional to the minimum flow section through the valve. Thus, for given flow quality, the flow rate of the fuel is determined completely by the value of the pressure difference from upstream to downstream across the metering valve, which is kept constant, and by the position of the shutter within the seat of the valve.

This position of the shutter is identified by a coordinate that can vary from a minimum coordinate, corresponding to the bottom abutment position of the shutter, and a maximum coordinate corresponding to the top abutment position of the shutter, these bottom and top abutment positions defining the ends of the maximum stroke of the shutter: such a coordinate may equally be well defined as some number of steps, as an angle, or as a distance traveled from the bottom abutment, or any other reference position, or as a distance ratio compared with the maximum stroke of the shutter, or indeed as any other appropriate unit.

Thus, in such a metering device, when the shutter moves from the bottom abutment towards the threshold position, the fuel flow increases linearly: in this range of positions, the fuel flow rate is thus an affine function of the position coordinate of the shutter. In other words, for each step of the shutter, the fuel flow rate increases or decreases by a given quantity.

In contrast, when the shutter travels from the threshold position towards the top abutment, the fuel flow rate increases quadratically or more rapidly: in this range of positions, the fuel flow rate is thus a function of the position coordinate of the shutter to the second degree, or to a higher degree, or an exponential function, or indeed any type of function having a rate of increase that is greater than that of a second degree function.

This metering device thus makes it possible to benefit from high resolution, i.e. fine adjustment of the flow rate, for each step of the shutter over a main range of positions of the shutter, while also making it possible to obtain flow rate peaks, and thus engine power peaks, in a second range of positions of the shutter, which second range may be of small extent. Furthermore, the metering benefits from being very robust in the main range since a small positioning error of the shutter, e.g. as a result of a failure of the actuator or of a resolver, degrades the flow rate obtained compared with the setpoint only a little, while larger metering errors can arise in the second range, which errors are less critical given the looked-for high flow rates, where such occasions requiring flow rate peaks are also infrequent.

Furthermore, such a metering device lends itself well to increases in nominal fuel flow rates subsequent to its design: such a device operating in its second range can achieve high flow rates that are compatible with an increase in nominal flow rates, while still conserving its robustness in its main range. It also lends itself easily to the pressure difference from upstream to downstream of the metering valve being reset, which may be done for the purpose of obtaining an overall increase in the flow rate passing through the valve, because of the ease of recalibration that is made possible by the linear nature of its main range.

In this description, the term “abutment” is used to mean an end of the stroke available to the shutter: such an abutment position may be embodied by an actual mechanical abutment preventing the shutter from moving beyond a certain point. Nevertheless, in certain embodiments, the metering device need not have any such mechanical abutments, it being the computer that prevents the shutter from moving beyond such abutment positions as programmed in the computer.

In certain embodiments, the metering device is configured so that the value of the minimum section of the passage through the metering valve is continuous in the vicinity of the threshold position of the shutter.

In certain embodiments, the minimum section of said passage increases quadratically as a function of the position coordinate of the shutter between the threshold position and the top abutment.

In other embodiments, the minimum section of said passage increases exponentially as a function of the coordinate of the position of the shutter between the threshold position and the top abutment.

In certain embodiments, the threshold position corresponds to the position of the shutter in which the flow rate of fuel passing through the valve is equal to a nominal operating flow rate of the engine. Thus, the metering device is called on to operate essentially in the range of positions lying between the bottom abutment and the threshold position, i.e. in the linear range where the metering device has greater resolution and robustness. In contrast, when the engine requires greater power, and thus a greater fuel flow rate, e.g. in an emergency situation, the shutter can go beyond the threshold position in order to reach the requested flow rate peak rapidly.

In certain embodiments, the bottom abutment corresponds to the position of the shutter in which the fuel flow rate is zero. In this way, the metering device can cut off the flow of fuel completely.

In certain embodiments, said engine is an aircraft engine and the nominal operating flow rate of the engine is the cruising nominal flow rate or the takeoff nominal flow rate.

In certain embodiments, the top abutment corresponds to the position of the shutter in which the fuel flow rate is equal to the emergency maximum flow rate of the engine. The metering device is thus capable of supplying the maximum flow rate to the engine enabling it to respond to emergency situations, e.g. the loss of one engine on an aircraft having a plurality of engines.

In certain embodiments, the threshold position is situated at a coordinate lying in the range 50% to 90% of the stroke of the shutter from the bottom abutment to the top abutment, and preferably in the range 60% to 80% of the stroke. Thus, a major portion of the stroke is reserved for the linear range, which is the range presenting better resolution and greater robustness, while the range of quadratic or more rapid growth may be of smaller extent, while conserving the possibility of reaching high flow rates.

In certain embodiments, the shutter is a plug turned about its central axis by the actuator, and said plug possesses a shutter ring configured to shut a varying section of the inlet orifice, the axial width of said shutter ring being constant between a bottom abutment azimuth and a threshold azimuth, and decreasing linearly between said threshold azimuth and a top abutment azimuth.

In certain embodiments, the shutter is a cam turned about its central axis by the actuator, and said cam possesses varying radial thickness so as to leave varying radial clearance between the inlet orifice and the cam, said radial thickness decreasing linearly between a bottom abutment azimuth and a threshold azimuth, and quadratically between said threshold azimuth and a top abutment azimuth.

In certain embodiments, the angular stroke of the shutter extends over an amplitude of 70° to 150°, preferably being about 85°.

In certain embodiments, the shutter is a valve needle driven axially along its central axis by the actuator, and said valve needle is movable within a constriction passage relative to which it leaves varying radial clearance.

In certain embodiments, the actuator is a stepper motor. Such a stepper motor provides accuracy and thus good resolution.

In certain embodiments, the stepper motor does not have step-down gearing. This serves to reduce both weight and cost while improving the reliability of the device.

In certain embodiments, the pressure regulator device is a differential valve.

The present description also relates to a turbine engine having a fuel feed circuit fitted with a metering device in accordance with any of the above-described embodiments.

The present description also provides a helicopter including a turbine engine in accordance with any of the above-described embodiments.

The above-described characteristics and advantages, and others, appear on reading the following detailed description of embodiments of the proposed metering device. This detailed description makes reference to the accompanying drawings.

### BRIEF DESCRIPTION OF THE DRAWINGS

The accompanying drawings are diagrammatic and seek above all to illustrate the principles of the invention.

In the drawings, from one figure to another, elements (or portions of an element) that are identical are referenced using the same reference signs. In addition, elements (or portions of an element) forming parts of different embodiments but that are analogous in function are referenced in the figures by numerical references that are incremented by 100, 200, . . . .

FIG. 1 is an overall diagram of a turbine engine fuel feed circuit having the metering device of the invention.

FIG. 2A is an axial section view of a first embodiment of the metering valve.

FIG. 2B is a perspective view of the shutter of the FIG. 2A valve.

FIG. 2C is a diagrammatic developed view of the shutter ring of the FIG. 2B shutter.

FIG. 2D is a plan view of the shutter ring of the FIG. 2B shutter.

FIG. 3 is a graph showing how the flow rate of fuel varies as a function of the position coordinate of the shutter.

FIG. 4A is an axial section view of a second embodiment of the metering valve.

FIG. 4B is a section view on plane B-B of FIG. 4A.

FIG. 5 is an axial section view of a third embodiment of the metering valve.

### DETAILED DESCRIPTION OF EMBODIMENTS

In order to make the invention more concrete, examples of metering devices are described below in detail with reference to the accompanying drawings. It should be recalled that the invention is not limited to these examples.

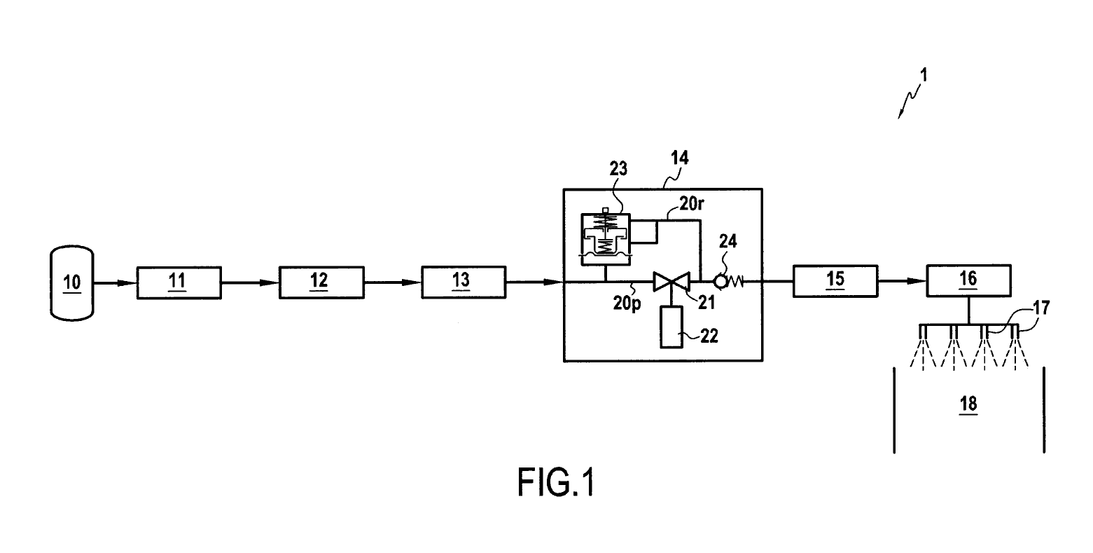

FIG. 1 is a diagrammatic view of a fuel feed circuit 1 for a helicopter turbine engine. Such a fuel feed circuit 1 has a low pressure pump 11, a circuit 12 for filtering, heating, and purging air, a high pressure pump 13, a metering device 14, a stop system 15, a distribution system 16, and injectors 17, with fuel passing through each of those elements from the tank 10 to the combustion chamber 18 of the turbine engine.

Fuel flows through the metering device 14 via a main line 20p having a metering valve 21 interposed thereon under the control of an actuator 22. In this embodiment, the actuator 22 is a stepper motor having no step-down gearing and controlled by the computer of the turbine engine. The metering device 14 also has a feedback line 20r connected to both sides of the valve 21 and including a differential valve 23 configured to regulate the pressure difference ΔP from downstream to upstream across the valve 21. In addition, the metering device 14 has an additional check valve 24 downstream from the metering valve 21.

In application of Bernoulli's theorem, since the pressure difference ΔP is kept constant and since differences in attitude are negligible, the flow rate of fuel passing through the metering valve 21 is controlled directly by the flow section made available by the valve 21.

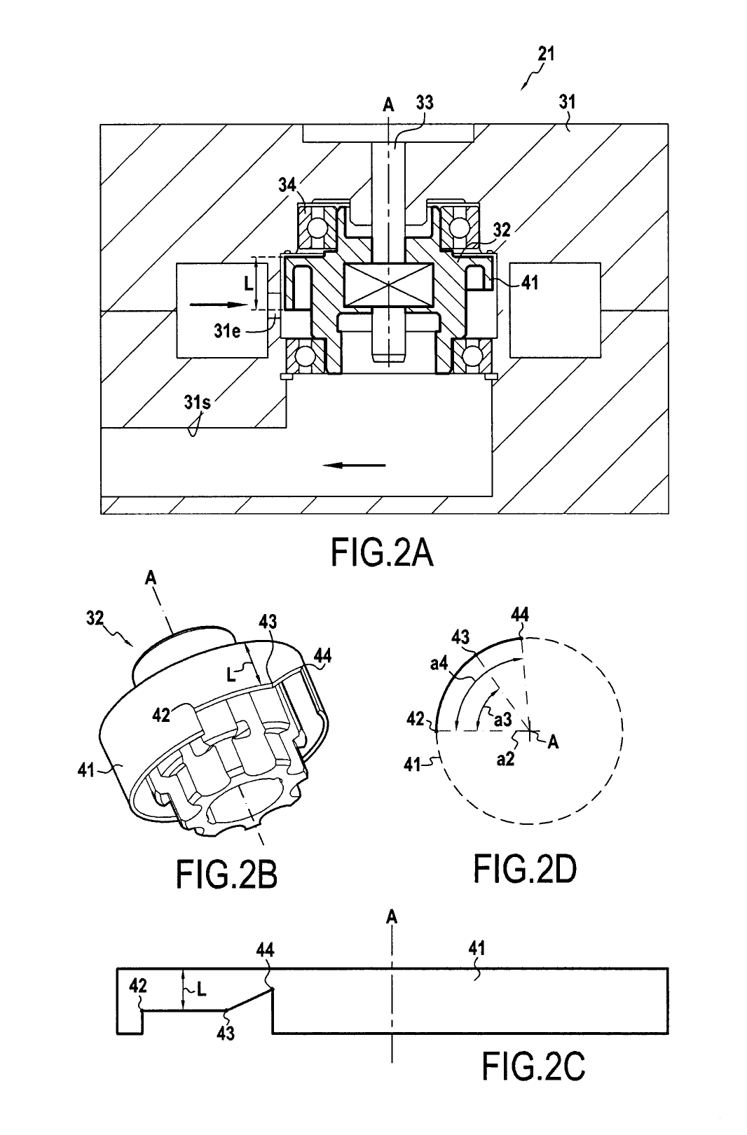

FIGS. 2A to 2D show a first embodiment of such a valve 21 of variable flow section. The valve 21 comprises a seat 31 with an inlet orifice 31e and an outlet orifice 31s receiving a plug 32 that is connected to the actuator 22 by a shaft 33 of axis A. The plug 32 is supported by ball bearings 34 allowing it to turn freely within the seat 31 under the control of the actuator 22. In addition, devices may be provided for taking up axial and angular slack so as to eliminate any axial or angular slack that might affect the position of the plug 32.

The plug 32 is substantially cylindrical in shape about the axis A, and has an annular ring 41 that is positioned in front of the inlet orifice 31e when the plug 32 is inserted in the seat 31. This annular ring 41 is of width L in the axial direction that varies so as to shut off a greater or lesser section of the inlet orifice 31e as a function of the position of the plug 32 relative to the seat 31. As shown in FIGS. 2C and 2D, behind a bottom abutment point 42, of azimuth a2 that is zero by convention, the axial width L of the shutter ring 41 is sufficient to shut off the inlet orifice 31e of the valve 21 completely. Thereafter, between this bottom abutment point 42 and a threshold point 43 of azimuth a3, the axial width L is constant, but smaller than upstream from the bottom abutment point 42, so as to open the inlet orifice 31e of the valve 21 in part. Then, on advancing to the threshold point 43, the flow area released at the inlet orifice 31e increases linearly. On continuing to advance along the shutter ring 41 clockwise from the threshold point 43, the axial width L then decreases linearly, i.e. in proportion to the distance traveled since the threshold point 43, until reaching a top abutment point 44 of azimuth a4, such that the flow area released at the inlet orifice 31e increases quadratically between the threshold point 43 and the top abutment point 44.

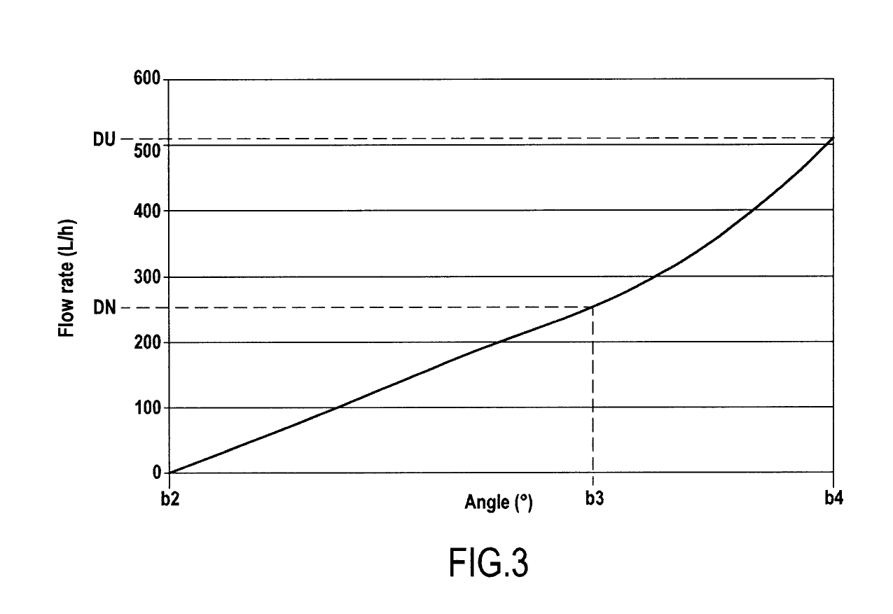

Thus, by means of such a shutter ring 41, it is possible to obtain a linear-and-quadratic metering relationship for the fuel as shown in FIG. 3. This graph shows how the fuel flow rate varies as a function of the position of the plug 32 identified by the angle it forms with the seat 31.

When the plug 32 is in its bottom abutment position, of angular coordinate b2 that by convention is zero, the end of the inlet orifice 31e of the seat 31 faces the bottom abutment point 42 of the shutter ring 41: the shutter ring 41 is thus located over the entire inlet orifice 31e; the flow rate setpoint is thus zero, and in FIG. 3 it can be seen that the fuel flow rate in this bottom abutment position is indeed zero or practically zero, ignoring some minimal leakage rate, if any. In other embodiments, the axial width L of the shutter ring 41 behind the bottom abutment point 42 could be selected so as to obtain a minimum flow rate that is not zero.

When the plug 32 is in its threshold position, identified by angular coordinate b3, the end of the inlet orifice 31e of the seat 31 is level with the threshold point 43 of the shutter ring 41: the axial width L of the shutter ring 41 between the bottom abutment point 42 and the threshold point 43 is selected so that the flow area at this threshold point 43 corresponds to a nominal flow rate DN of the turbine engine. In this embodiment, the nominal flow rate DN is the flow rate that corresponds to the maximum takeoff power MTP at ground level; nevertheless, it could equally well correspond to the maximum cruising power MTP at ground level. In this embodiment, the threshold position of the plug 32 is situated at about 66% of its stroke from the bottom abutment to the top abutment, i.e. giving an angular coordinate b3 of about 55°.

When the plug 32 is in its top abutment position, identified by angular coordinate b4, the end of the inlet orifice 31e of the seat 31 is substantially level with the top abutment point 44 of the shutter ring 41: the axial width L of the shutter ring 41 at this top abutment point 44 is selected to that the flow area at this top abutment point 44 corresponds to an emergency maximum flow rate DU of the turbine engine. In this embodiment, this emergency flow rate DU corresponds to the regulation flow rate for one engine inoperative (OEI) conditions.

In this embodiment, the maximum stroke of the plug 32 from the bottom abutment to the top abutment extends over about 85° . Nevertheless, it could equally well be longer than that, e.g. in the range 110° to 150°.

Thus, as can be seen in FIG. 3, the configuration of the shutter ring 41 serves to obtain a linear metering relationship between the bottom abutment position of angular coordinate b2 up to the threshold position, of angular coordinate b3, and a quadratic metering relationship from the threshold position up to the top abutment position, of angular coordinate b4. Under such circumstances, with this relationship being programmed in the computer of the turbine engine, the computer is capable of controlling the plug 32 using the stepper motor 22 in order to bring it into the position that matches the setpoint flow rate that has been specified to the computer.

In the above-described example, it is the shutter ring of the plug that is of varying shape in order to adjust the fuel flow rate as a function of the angular position of the plug; nevertheless, this varying profile could equally well be carried by the inlet orifice 31e of the seat 31 with the cutout in the shutter ring 41 being of constant axial width L. More generally, it is possible to imagine any combination of profiles between the shutter ring 41 and the inlet orifice 31e so long as that combination leads to the desired variation in the flow section as a function of the angular position of the plug and thus to the desired variation in the flow rate: for example, it is possible to imagine a helical ramp of constant slope on the shutter ring 41 associated with an appropriate shape for the inlet orifice 31e.

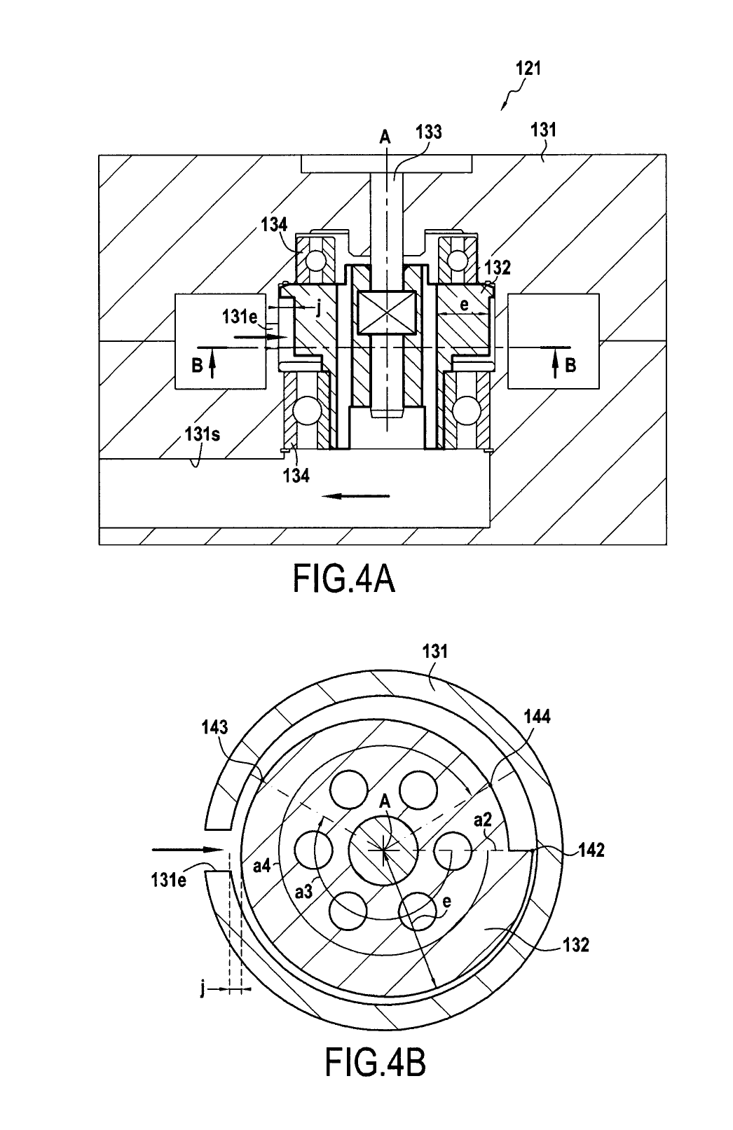

FIGS. 4A and 4B show a second embodiment of a metering valve 121 of variable flow section. This valve 121 has a seat 131 provided with an inlet orifice 131e and an outlet orifice 131s, with a cam 132 received therein and connected to its actuator 22 by a shaft 133 of axis A. The cam 132 is supported by ball bearings 134 enabling it to turn freely within the seat 131 under the control of the actuator 22. In addition, axial and angular slack takeup devices may be provided for eliminating any axial or angular slack that might affect the position of the cam 132.

When the cam 132 is inserted in the seat 131, it is positioned in the proximity of the inlet orifice 131e. It possesses radial thickness e that varies so as to leave greater or lesser radial clearance j in front of the inlet orifice 131e as a function of its position relative to the seat 131. Thus, as can be seen in FIG. 4B, at a bottom actuator point 142 of azimuth a2 that is zero by convention, the radial thickness e of the cam 132 is sufficient to shut off completely the inlet orifice 131e of the valve 121. Then, on advancing along the cam 132 in the clockwise direction, this radial thickness e decreases linearly, i.e. in proportion to the distance traveled, up to a threshold point 143 of azimuth a3. On continuing to advance along the cam 132 in the clockwise direction from the threshold point 143, its radial thickness e then decreases quadratically, i.e. in proportion to the square of the distance traveled from the threshold point 143, up to a top actuator point 144 of azimuth a4.

Such a cam 132 of varying radial thickness e enables a linear-and-quadratic metering relationship to be obtained for fuel analogous to that described above and shown in FIG. 3.

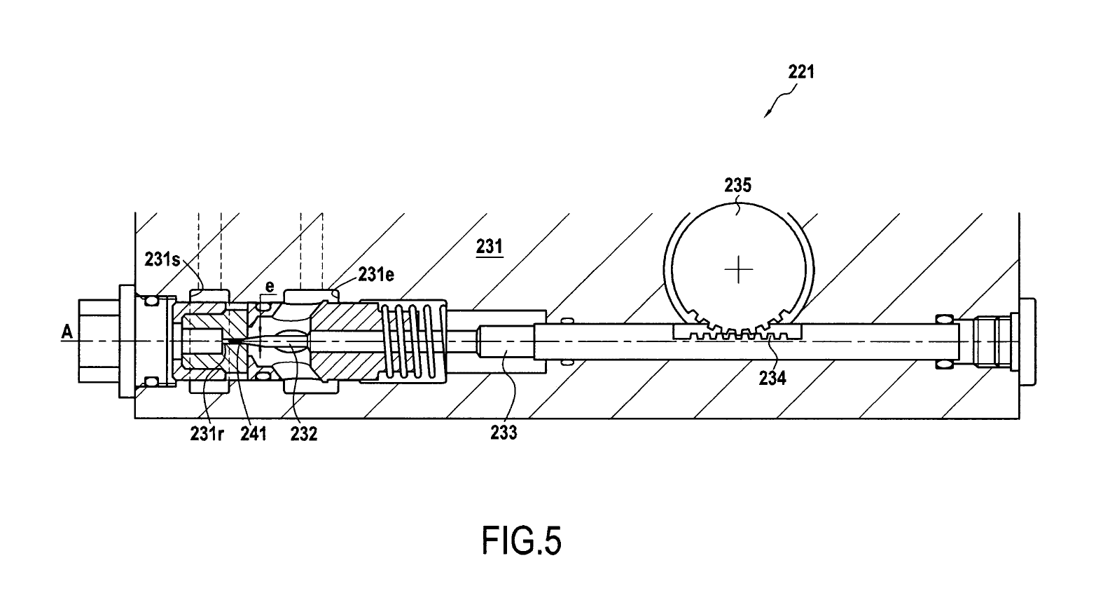

FIG. 5 shows a third embodiment of a metering valve 221 of varying flow section. This valve 221 has a seat 231 provided with an inlet orifice 231e, an outlet orifice 231s, and a constriction passage 231r. A needle 232 is inserted in the seat 231 so that its tip 241 engages in the constriction passage 231r. The needle 232 is secured to a rod 233 having a rack 234 meshing with a pinion 235 of the actuator 22, thereby enabling the actuator 22 to drive the needle 232 along its axis A.

The tip 241 of the needle is of radial thickness e that varies so as to leave greater or lesser clearance relative to the walls of the constriction passage 231r as a function of the position of the needle 232 relative to the seat 231. In manner analogous to the above-described embodiments, at a bottom abutment point the radial thickness e of the tip 241 is sufficient to shut off completely the constriction passage 231r. Then on advancing along the tip, this radial thickness e decreases such that the flow section of the constriction increases linearly, i.e. in proportion to the distance traveled by the tip, up to a threshold point. Continuing to advance along the tip 241 from the threshold point causes the radial thickness e then to decrease in such a manner that the flow section of the constriction increases quadratically, i.e. in proportion to the square of the distance traveled by the needle from the threshold point, until a top abutment point is reached.

Such a needle 232 of radial thickness e that varies makes it possible once more to obtain a linear-and-quadratic metering relationship for fuel that is analogous to that described above and shown in FIG. 3.

The embodiments described in the present description are given by way of non-limiting illustration, and in the light of this description, a person skilled in the art can easily modify these embodiments or envisage others, while remaining within the ambit of the invention.

Furthermore, the various characteristics of these embodiments may be used singly or in combination with one another. When they are combined, these characteristics may be combined as described above or in other ways, the invention not being limited to the specific descriptions described in the present description. In particular, unless specified to the contrary, a characteristic described with reference to any one embodiment may be applied in analogous manner to some other embodiment.

1. A metering device for an engine fuel feed circuit, the device comprising:
a metering valve; and
a pressure regulator device maintaining a constant pressure difference from downstream to upstream across the metering valve;
wherein the metering valve comprises:
a seat provided with an inlet orifice and an outlet orifice;
a shutter arranged within the seat; and
an actuator controlling the position of the shutter; and
wherein, between the inlet orifice and the outlet orifice, the shutter defines a passage of minimum section that is variable as a function of the position of the shutter along a stroke extending between a bottom abutment and a top abutment and passing via a threshold position;
wherein the shutter is configured in such a manner that, firstly, the minimum section of said passage, and thus the flow rate of fuel passing through the valve, increases linearly as a function of the position coordinate of the shutter between the bottom abutment (b2) and the threshold position, and that, secondly, the minimum section of said passage, and thus of the fuel flow rate, increases quadratically or more rapidly, as a function of the position coordinate of the shutter between the threshold position and the top abutment.

2. A metering device according to claim 1, wherein the threshold position corresponds to the position of the shutter in which the flow rate of fuel passing through the valve is equal to the cruising nominal flow rate or the takeoff nominal flow rate when said engine is an aircraft engine.

3. A metering device according to claim 1, wherein the top abutment corresponds to the position of the shutter in which the fuel flow rate is equal to the emergency maximum flow rate of the engine.

4. A metering device according to claim 1, wherein the threshold position is situated at a coordinate lying in the range 50% to 90% of the stroke of the shutter from the bottom abutment to the top abutment.

5. A metering device according to claim 1, wherein the shutter is a plug turned about its central axis by the actuator, and wherein said plug possesses a shutter ring configured to shut a varying section of the inlet orifice, the axial width of said shutter ring being constant between a bottom abutment azimuth and a threshold azimuth, and decreasing linearly between said threshold azimuth and a top abutment azimuth.

6. A metering device according to claim 1, wherein the shutter is a cam turned about its central axis by the actuator, and in that said cam possesses varying radial thickness so as to leave varying radial clearance between the inlet orifice and the cam, said radial thickness decreasing linearly between a bottom abutment azimuth and a threshold azimuth, and quadratically between said threshold azimuth and a top abutment azimuth.

7. A metering device according to claim 1, wherein the shutter is a valve needle driven axially along its central axis by the actuator, and wherein said valve needle is movable within a constriction passage relative to which it leaves varying radial clearance.

8. A metering device according to claim 1, wherein the actuator is a stepper motor, without step-down gearing.

9. A turbine engine, comprising a fuel feed circuit fitted with a metering device according to claim 1.

10. A helicopter, comprising a turbine engine according to claim 9.
